(19) United States
(12) Patent Application Publication
(10) Pub. No.: US 2022/0379328 A1
(43) Pub. Date: Dec. 1, 2022

(54) Portable Pressurized On-Demand Water Source

(71) Applicant: Outdoor Culture, Inc., Vista, CA (US)

(72) Inventor: Christopher Jackson Crawford, Carlsbad, CA (US)

(21) Appl. No.: 17/829,176

(22) Filed: May 31, 2022

Related U.S. Application Data
(60) Provisional application No. 63/202,218, filed on Jun. 1, 2021.

(51) Int. Cl. B05B 9/08; B05B 9/00; B05B 12/12

(52) U.S. Cl. CPC B05B 9/0861; B05B 9/002; B05B 12/122; H02J 7/0045

(57) ABSTRACT

A portable fresh water source that can dispense water under pressure through a hand-held nozzle for utility and recreational uses, such as for rinsing saltwater from marine equipment, washing hands, showering, cleaning dishes, watering plants, or any other activity in which a portable on-demand fresh water source would be useful. The portable fresh water source includes a reservoir, a battery, a pressurizing pump, and a dispensing apparatus. The battery provides power to the pressurizing pump, which in turn provides water pressure to the dispensing apparatus. A version of the dispensing apparatus is a hose with a nozzle. Another version has a hands-free nozzle to allow a user to control the system without touching the device.

### RELATED APPLICATION

This application claims priority to U.S. Provisional Patent Application Ser. No. 63/202,218 for a “Portable Pressurized On-Demand Water Source,” filed Jun. 1, 2021, and currently co-pending, the entirety of which is incorporated herein by reference.

### FIELD OF THE INVENTION

The present invention pertains generally to portable water sources. The present invention, more particularly though not exclusively, is useful for a portable fresh water source that can dispense water under pressure through a hand-held nozzle.

### BACKGROUND OF THE INVENTION

Common recreational activities, such as camping, involve travel to locations where running water—and often potable water in general—is unavailable. In response to the lack of potable water, participants in such activities sometimes bring water in containers, and sometimes bring filters and chemical treatment for locally sourced water, if sources (such as streams) are present. Nonetheless, transporting or treating water only provides a partial solution, as the conveniences of running water are still lacking.

In view of the above, it would be advantageous to provide a system for running water that can be used in remote locations.

### SUMMARY OF THE INVENTION

Disclosed is a portable fresh water source that can dispense water under pressure through a hand-held nozzle for utility and recreational uses, such as for rinsing saltwater from marine equipment, washing hands, showering, cleaning dishes, watering plants, or any other activity in which a portable on-demand fresh water source would be useful. Additionally, in addition to fresh water, the present invention may be used to dispense bleach, cleaning solutions, deicing brine solutions, or any other liquid, and may serve as a portable eye-wash and anti-contamination station. The present invention may also be equipped with a hands-free nozzle to allow a user to control the system without touching the device.

A preferred embodiment of the portable fresh water source includes a reservoir, a battery, a pressurizing pump, and a dispensing apparatus. The battery provides power to the pressurizing pump, which in turn provides water pressure to the dispensing apparatus. In a preferred embodiment, the dispensing apparatus is a hose and handheld or hands-free nozzle.

In some embodiments, the pump pressurizes the water or other liquid in the reservoir by pumping air into the reservoir until a predetermined maximum pressure is reached. The pump then shuts off until a predetermined minimum pressure is reached as water is dispensed, at which point the pump is reactivated to maintain water pressure in the reservoir.

Some embodiments include a heating element in order to heat the water stored in the portable pressurized on-demand water source.

In an alternate preferred embodiment, the dispensing apparatus includes a motion activated hands-free shower head, allowing hands-free operation of the portable fresh water source.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a perspective view of a preferred embodiment of a portable pressurized on-demand water source;

FIG. 2 is another perspective view of the portable pressurized on-demand water source, with the lid in an open configuration and showing the dispensing apparatus and control panel;

FIG. 3A illustrates a hinge connecting the lid to the housing of the portable pressurized on-demand water source;

FIG. 3B illustrates the hinge in a disconnected configuration;

FIG. 4A is a top-down view of the portable pressurized on-demand water source, showing a hose and spray nozzle of the dispensing apparatus within the housing;

FIG. 4B is another top-down view of the portable pressurized on-demand water source, showing the hose extended from the chassis;

FIG. 5 is a top-down view of the portable pressurized on-demand water source with the lid removed;

FIG. 6 is a perspective view of the portable pressurized on-demand water source showing the lid in a closed configuration with the hose extended outside the housing;

FIG. 7A is a detail view of the upper surface of a reservoir cap of the portable pressurized on-demand water source;

FIG. 7B is a detail view of the underside of the reservoir cap of the portable pressurized on-demand water source;

FIG. 8 illustrates the portable pressurized on-demand water source with the chassis removed, showing the battery and pump assembly;

FIG. 9 is a side view of the pump assembly of the portable pressurized on-demand water source;

FIG. 10 is a front view of the pump assembly of the portable pressurized on-demand water source;

FIG. 11 is a rear view of the pump assembly of the portable pressurized on-demand water source;

FIG. 12 is a back view of the control panel of the portable pressurized on-demand water source;

FIG. 13 is a top view of the portable pressurized on-demand water source showing the accessibility of the control panel when in use;

FIG. 14 is a detail view of the spray nozzle of the portable pressurized on-demand water source;

FIG. 15 illustrates the face of a hands-free head of an alternative embodiment of a spray nozzle of the portable pressurized on-demand water source;

FIG. 16A is a side view of the spray nozzle of the portable pressurized on-demand water source in an attached configuration in which it is attached to the hose;

FIG. 16B is a side view of the spray nozzle of the portable pressurized on-demand water source in a detached configuration in which it is detached from the hose;

FIG. 17 is a perspective view of the hands-free head of the portable pressurized on-demand water source;

FIG. 18A is a side view of the hands-free head of the portable pressurized on-demand water source in an attached configuration in which it is attached to the hose;

FIG. 18B is a side view of the hands-free head of the portable pressurized on-demand water source in a detached configuration in which it is detached from the hose;

FIG. 19 illustrates additional attachment devices for the hands-free head of the portable pressurized on-demand water source;

FIG. 20 illustrates a mounting bracket for the hands-free head of the portable pressurized on-demand water source;

FIG. 21 is a schematic of the portable pressurized on-demand water source;

FIG. 22 is a schematic of an alternative embodiment of the portable pressurized on-demand water source; and

FIG. 23 is a diagram of an alternative embodiment of the portable pressurized on-demand water source.

### DETAILED DESCRIPTION

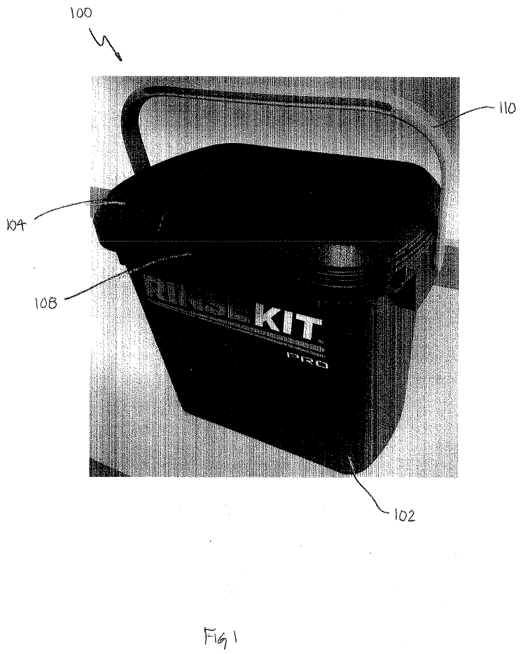

FIG. 1 is a perspective view of the Portable Pressurized On-Demand Water Source of the present invention and generally designated 100. Water source 100 includes a housing 102 sized to receive a reservoir having a volume of water therein. A lid 104 closes housing 102 and can be secured in place with latch 108, and the Water source 100 may be easily transported with handle 110 which can be positioned above the device for transport, or lowered to the front or back of the housing 102 to avoid interference during use.

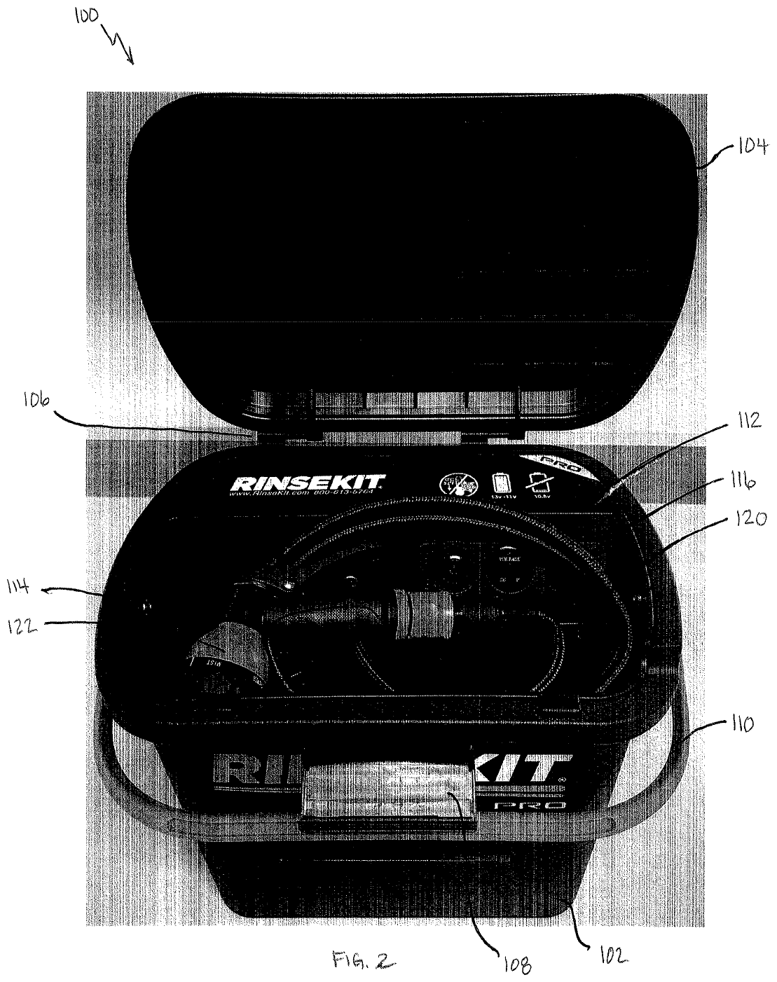

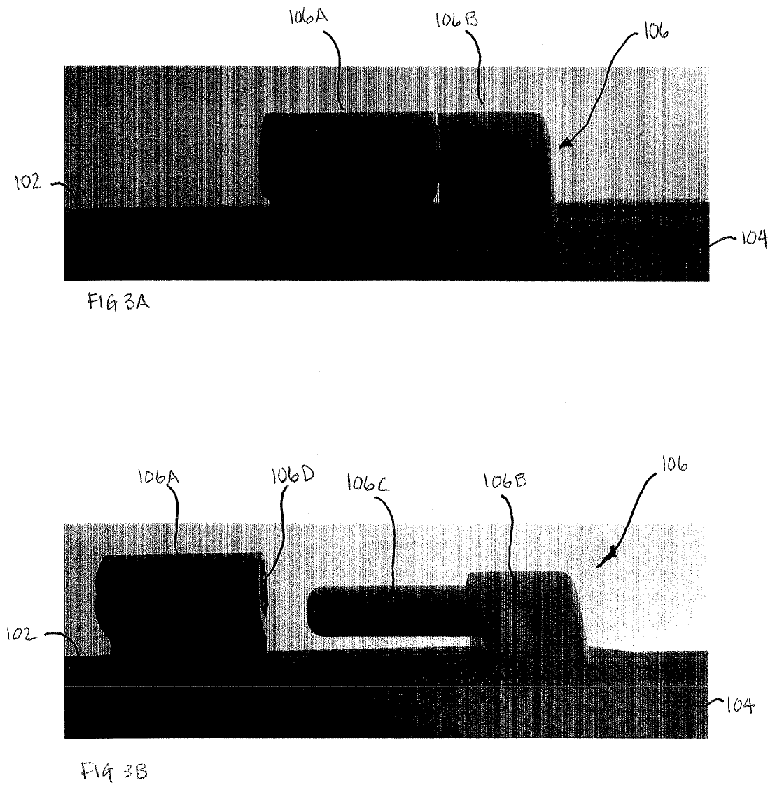

FIG. 2 is a perspective view of the Portable Pressurized On-Demand Water Source 100 with the lid 104 in the open position and revealing hinges 106 that allow the lid 104 to be raised and lowered from housing 102. Referring briefly to FIGS. 3A and 3B, the hinge 106 is shown to have a first part 106A that extends from the upper rim of housing 102 and is formed with a bore 106D, and a second part 106B that is formed on the lid 104 and formed with a post 106C. In FIG. 3A, the lid 104 is attached to housing 102 with the first part 106A and the second part 106B adjacent, with post 106C extending into bore 106D.. In FIG. 3B, the lid 104 slides along the axis of post 106C such that post 106C is removed from bore 106D thus separating the lid 104 from housing 102. This allows for the easy access to the pump assembly discussed below.

Referring back to FIG. 2, with lid 104 in the raised position, the contents of housing 102 are shown. Housing 102 includes a chassis 112 that is secured within housing 102 with fasteners 114, such as screws. Other fasteners can be used without departing from the present invention as the purpose of fasteners 114 is to secure chassis 112 within housing 102 even when an internal reservoir is full of water. Chassis 112 is equipped with a control panel 116 which provides the user charging port, voltmeter and control switch (discussed below).

Chassis 112 is formed to receive a length of hose 120 and an associated spray nozzle 122 such that when the Portable Pressurized On-Demand Water Source 100 is being transported, the hose 120 and spray nozzle 122 are securely contained withing housing 102 and lid 104.

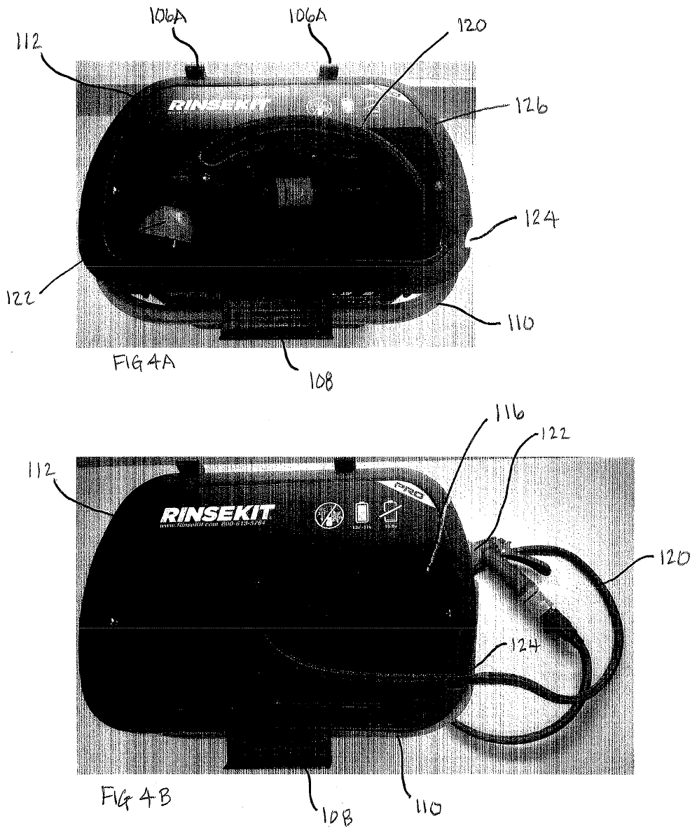

Referring now to FIG. 4A and 4B, the Portable Pressurized On-Demand Water Source 100 is shown in a first configuration in which the hose 120 and spray nozzle 122 are positioned within housing 102 above chassis 112, and a second configuration in which the hose 120 extends from chassis 112, passes through a hose notch 124 and out of housing 102. As shown, notch 124 is formed in the upper rim 126 of housing 102 and sized to provide easy passage of hose 120 from chassis 112 to spray nozzle 122 even with lid 104 in the closed position.

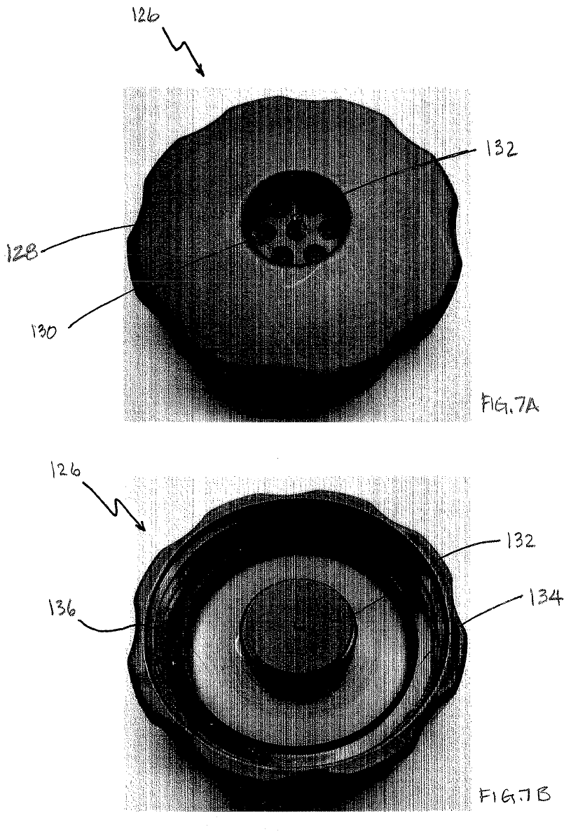

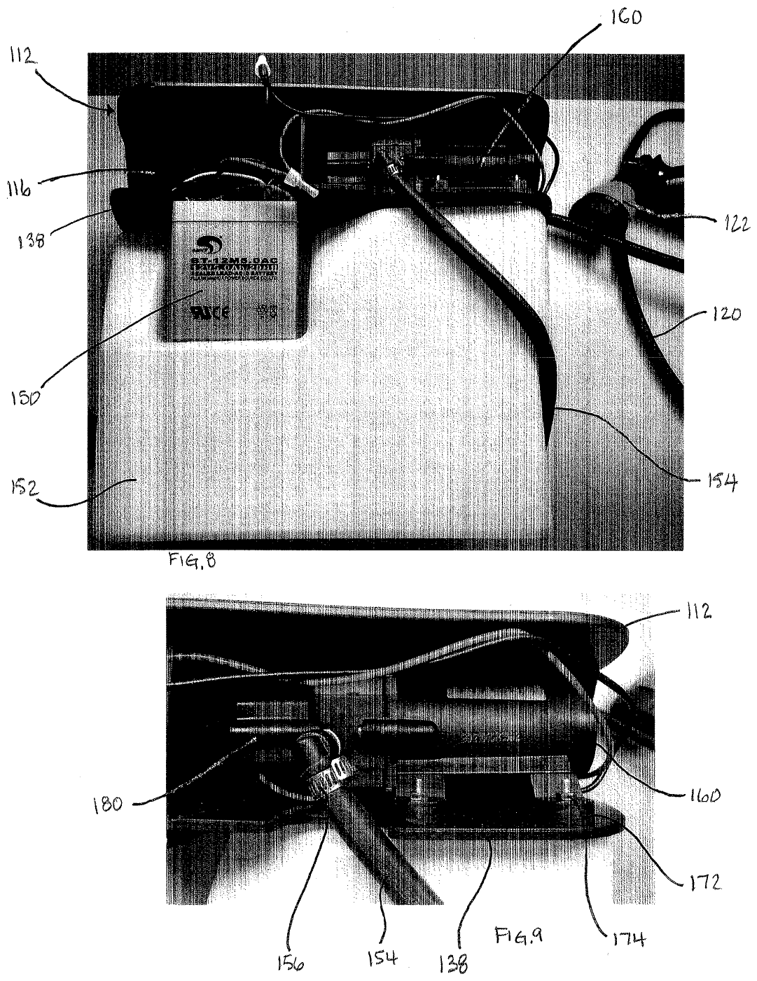

Referring briefly to FIG. 5, a top view of the Portable Pressurized On-Demand Water Source 100 is shown with lid 104 removed and showing the hose 120 passing through notch 124 in upper rim 126 of housing 102. Also from this view, cap 126 is shown that seals the opening of a reservoir 152 (shown in FIG. 8). Cap 126 is shown in greater detail in FIGS. 7A and 7B. Specifically, cap 126 includes a cap body 128 that is formed with an array of air vents 130 which pass through the cap body 128. A deformable vent seal 132 is attached to cap body 128 adjacent air vents 130 such that the ambient air can pass freely through cap 126 from outside ambient to inside the reservoir 152. FIG. 7B shows the underside of cap 126, and the placement of deformable vent seal 132 over air vents 130. It is to be understood that this deformable vent seal 132 is an example of a preferred embodiment of a one-way air valve allowing air to pass freely through cap 128 and into reservoir 152, while prevent air or water from leaving reservoir 152. Other types of one-way valves are fully contemplated herein without departing from the present invention. Cap 126 is formed with threads 136 which correspond with the opening to reservoir 152, and can be equipped with a sealing ring 134 to securely seal cap 126 to reservoir 152.

Returning to FIG. 5, the control panel 116 is shown and has a charging port 142, a battery status meter 144 and an ON/OFF switch 146. The operation of these electrical components will be more fully described in conjunction with FIGS. 21 and 22, however, for the purpose of this view, it can be easily appreciated that the controls are easily accessible when the lid 104 is open or removed, and also that any charging cable can be easily passed through notch 124, alone or in combination with hose 120, while the lid 104 is closed and secured tightly against housing 102 with latch 108.

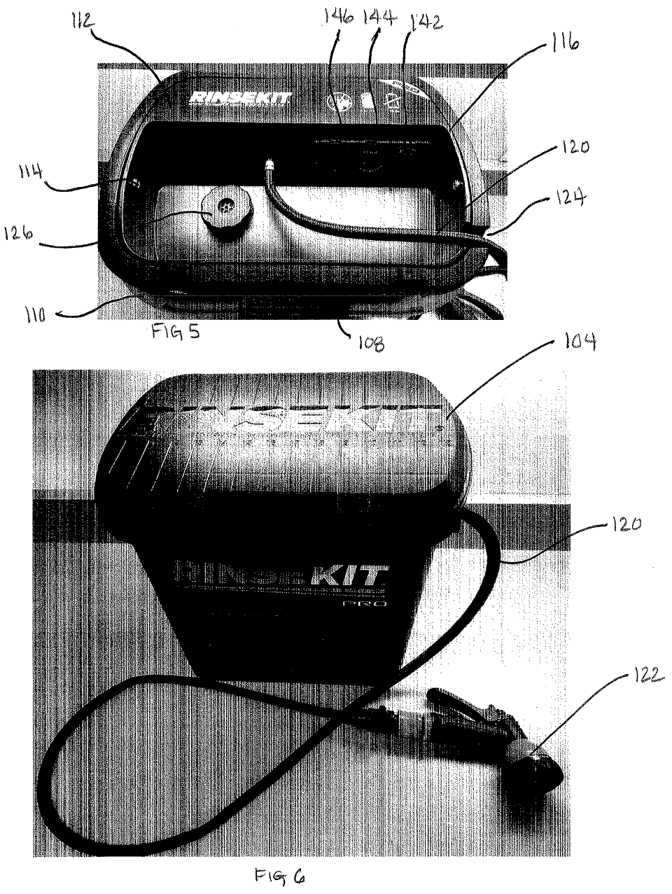

FIG. 6 shows the Portable Pressurized On-Demand Water Source 100 with the lid 104 in the closed and locked position against housing 102, with hose 120 leaving housing 102 allowing for the easy use of spray nozzle 122 while remaining easily portable. This allows for the ON-OFF switch 146 to be in the ON position, and the user can easily grab handle 110 and move device 100 wherever the water source is required. This high degree of portability is particularly suited when washing down larger items, such as boats, off-road vehicles, and personal watercraft, or the washdown of anything larger than the hose length alone would allow.

Referring now to FIG. 8, chassis 112 is shown removed from housing 102 following removal of fasteners 114. From this view, the backside of control panel 116 is shown along with wiring connecting to battery 150 and pump assembly 160. Pump assembly 160 is mounted to base 138 of chassis 112 and is discussed in greater detail in conjunction with FIGS. 9, 10 and 11, however, pump inlet hose 154 is shown here extending from the lower portion of reservoir 152 to supply water to pump assembly 160. Pump assembly 160 is shown having mounting feet 172 attached to base 138 and secured with fasteners 174.

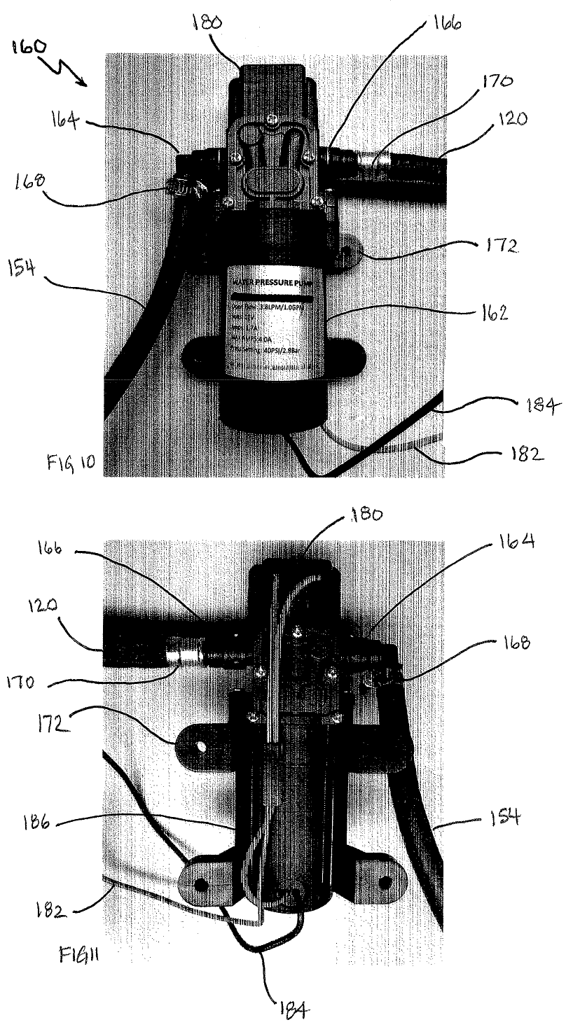

Referring now to FIGS. 10 and 11, pump assembly 160 is shown and includes pump inlet hose 154 secured to the inlet side 164 of pump 162 by worm, or hose, clamp 168. As water is drawn from reservoir 152 through pump inlet hose 154, pump 162 acts on the water, and pressurized water exits pump outlet side 166 to hose 120 that is secured in place with compression clamp 170. Other clamp types can be used as is known in the art.

Pump assembly 160 includes a pressure regulator 180 that monitors the pressure of the fluid in pump outlet side 166 and when the pressure reaches a maximum level, the pressure regulator interrupts the voltage to pump 162. Specifically, from FIG. 11 pump 162 is connected to voltage negative wire 184. Voltage positive wire 182 provides voltage to pump assembly 160 and is connected to pressure regulator 180 that is normally electrically closed in the absence of maximum pressure in pump outlet side 166. In this case of a normally electrically closed pressure regulator 180, voltage passes through closed pressure regulator 180 on wire 186 to pump 162 such that water is drawn from reservoir 152 through inlet side 164 and pumped out the outlet side 166. If the spray nozzle 122 is open, water will continuously flow. However, if the spray nozzle 122 is closed, the water pressure within hose 120 will build to a maximum pressure, the pressure regulator will be activated thus becoming an open electrical connection thereby interrupting the flow of voltage to wire 186 and pump 162. This pressure regulator 180 prevents an over-pressurization of water in hose 120 that could harm the hose 120 or nozzle 122, and also prevents an over-heating of pump 162 due to the exceedingly high pressure that would otherwise occur absent the pressure regulator 180. Pressure regulator 180 may be preset with a maximum pressure of 40 psi, for example, but it is to be appreciated that other pressure settings could be used without departing from the present invention.

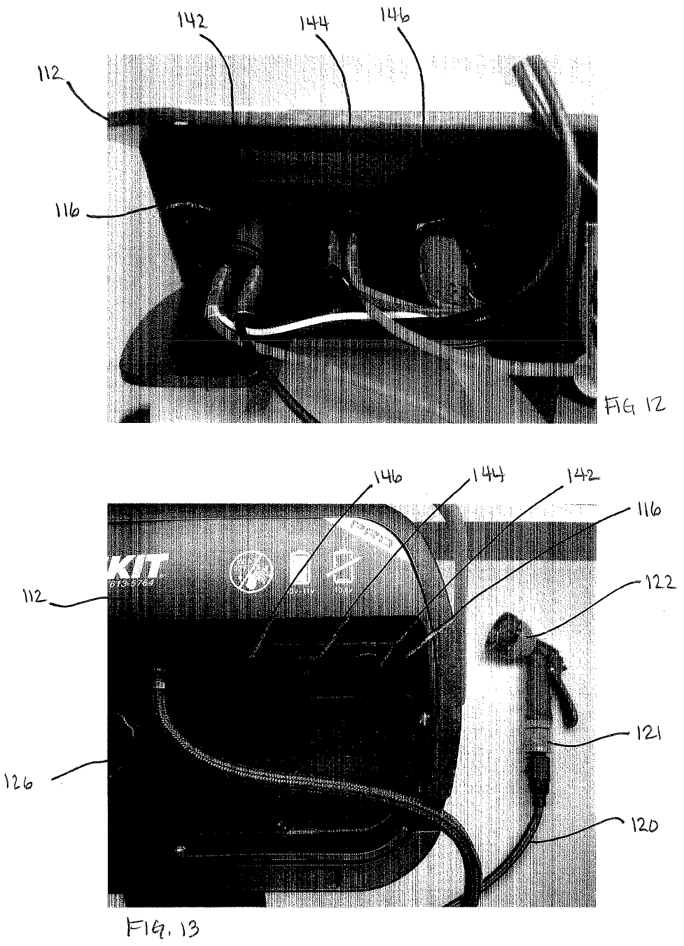

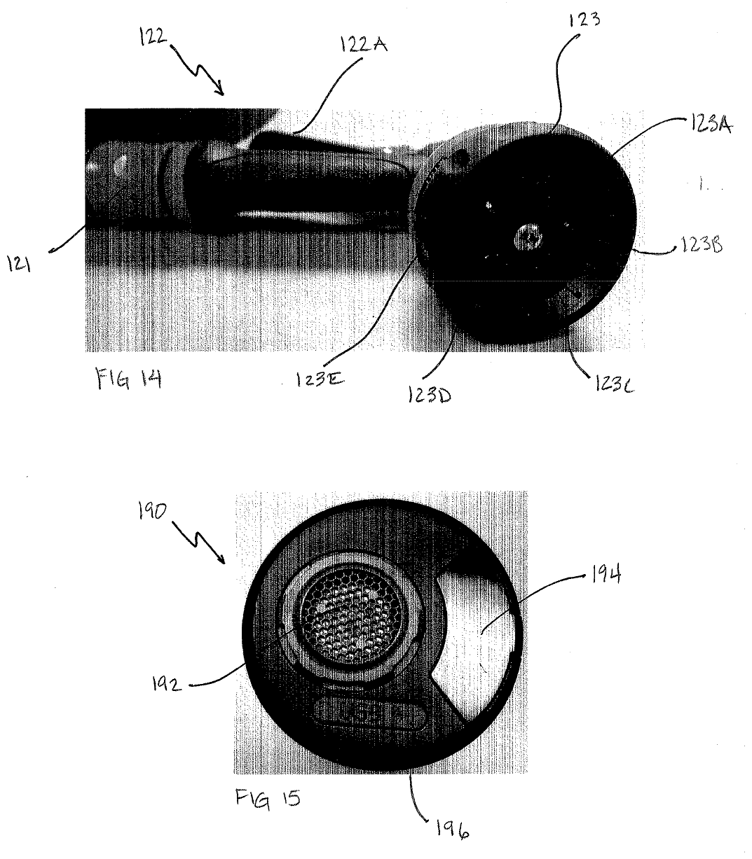

FIG. 12 is a view of the back side of control panel 116 and shows the placement of the charging port 142, a battery status meter 144 and an ON/OFF switch 146. The particular wiring will be discussed in conjunction with FIGS. 21 and 22. FIG. 13 is a top view of the Portable Pressurized On-Demand Water Source 100 showing the easy access of the control panel 116 when in use.

Spray nozzle 122 has been discussed generally herein, and referring now to FIG. 14, the various components of spray nozzle 122 are detailed. Specifically, spray nozzle 122 includes a quick-disconnect coupler 121 that allows the rapid connection and disconnection of spray nozzle 122, or other accessories, from hose 120. In this embodiment, spray nozzle 122 includes a spray head 123 that has a rotatable head having various nozzle apertures 123A, 123B, 123C, 123D, and 123E representing a spray shower, large stream, blade spray, gentle shower, and narrow stream, respectively. By rotating the head, each of the various nozzle apertures are available for use. Once the appropriate nozzle is selected, spray lever 122A is depressed and water flows from hose 120 out through aperture 123.

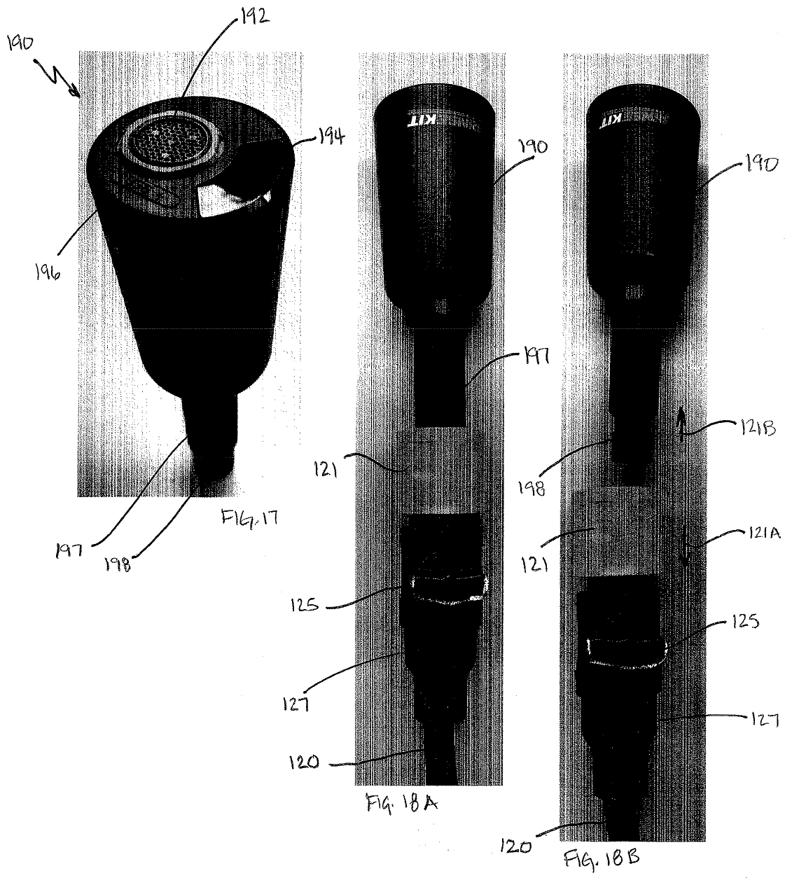

Referring ahead to FIGS. 16A and 16B, the spray nozzle 122 is shown as attached and detached from hose 120. Specifically, nozzle 122 is attached to quick-disconnect coupler 121 which extends from ON/OFF valve 127 on fitting 127 at the end of hose 120. When spray nozzle 122 is attached to quick-disconnect coupler 121, valve 127 is opened, and when spray lever 122A is depressed, water flows from hose 120 out spray nozzle 122. When valve 127 is rotated in direction 125A, the valve closes and water flow is interrupted. Once the water flow is interrupted, quick-disconnect coupler 121 is moved in direction 121A and spray nozzle 122 is pulled in direction 121B to release and disconnect nipple 122B of spray nozzle 122 from quick-disconnect coupler 121. Opening valve 127 by rotation in direction opposite direction 125A allows water to flow from hose 120 even if no spray nozzle 122 was connected.

To attach a spray nozzle 122 to quick-disconnect coupler 121, the nipple 122B of spray nozzle122 is inserted in direction opposite direction 121B into quick-disconnect coupler 121 while simultaneously moving quick-disconnect coupler 121 in direction 121A. Once spray nozzle 122 is fully inserted into quick-disconnect coupler 121 is released to return the coupler to its resting position holding spray nozzle 122 in fluid communication with hose 120.

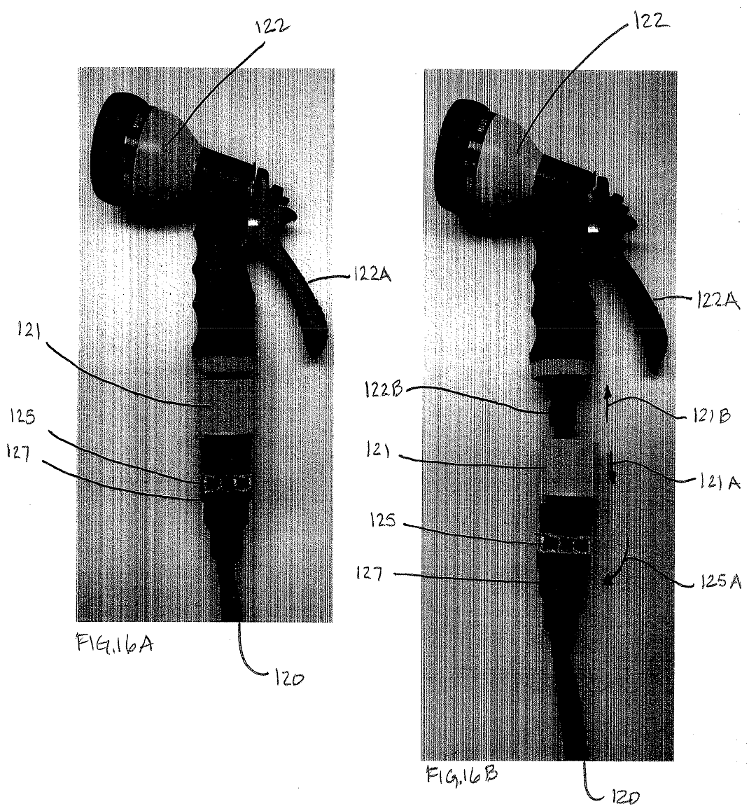

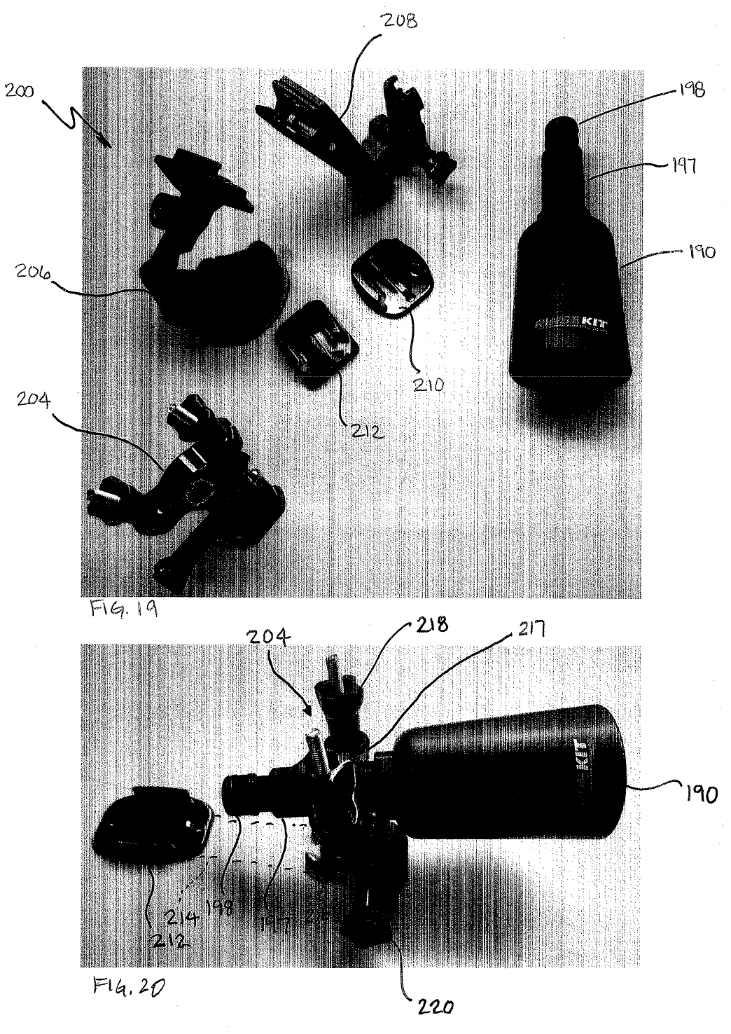

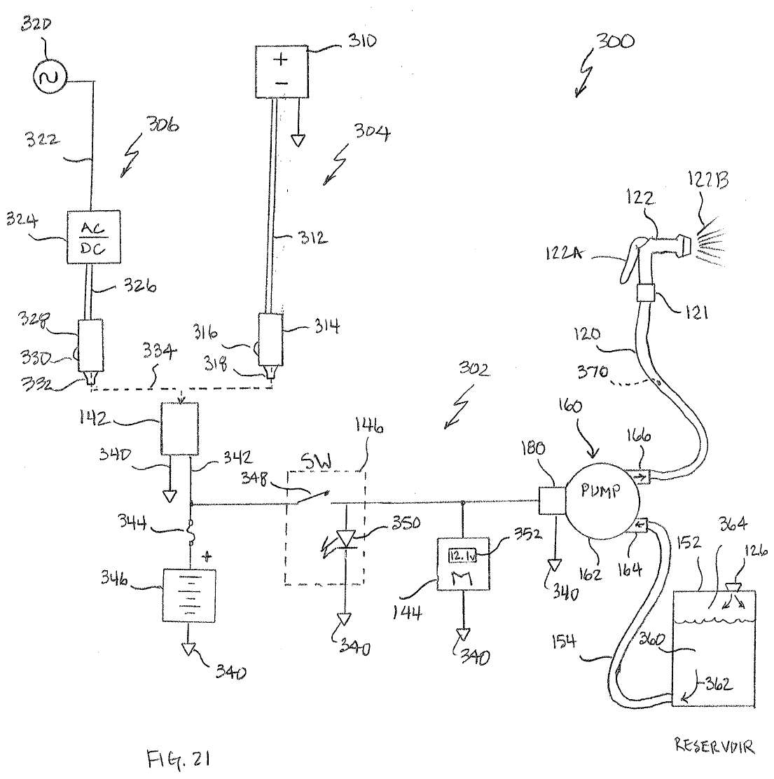

Referring now to FIG. 15, an alternative to spray nozzle 122 is provided in an alternative embodiment of the Portable Pressurized On-Demand Water Source 100. Hands-free head 190 is provided and includes a spray nozzle 192 activated by a battery operated motion sensor 194 and rechargeable using a USB port 196. Additional views of hands-free head 190 are shown in FIGS. 17 and 18A and 18B. Specifically, hands-free head 190 includes spray nozzle 192 that is in fluid communication with an internal valve (not shown) that when activated, allows water to flow from nipple 198 through pipe 197 and out nozzle 192. The operation of motion sensor 194 is controlled by a circuit within hands-free head 190 that includes a battery so that there is no need to provide power to hands-free head 190 during use. The internal battery can be recharged using a standard USB cord through port 196 as is known in the art, and will provide for an extended period of use.

Attachment and detachment of hands-free head 190 from quick-disconnect coupler 121 are shown in FIGS. 18A and 18B. In FIG. 18A, hands-free head 190 is shown fully inserted into quick-disconnect coupler 121 for use. When valve 127 is rotated as described above, water flows from hose 120, through valve 127 and, when motion sensor 194 is activated, out spray nozzle 192.

Removal of hands-free head 190 from quick-disconnect coupler 121 is similar to that described in conjunction with spray nozzle 122, and includes movement of quick-disconnect coupler 121 in direction 121A while hands-free head 190 is pulled in direction 121B. Reattachment can be accomplished by movement of hands-free head 190 in direction opposite direction 121B so that nipple 198 inserts into quick-disconnect coupler 121, while simultaneously moving quick-disconnect coupler 121 in direction 121A until nipple 198 is fully seated, then releasing the quick-connect coupler 121.

Portable Pressurized On-Demand Water Source 100 includes a variety of assorted attachment devices generally shown in FIG. 19 and designated 200. For instance, a mounting bracket 204 is provided to receive tube 197 of hands-free head 190. Alternatively, a suction mount 206 may be used to attach the hands-free head 190 to any smooth surface. Also, a clamp attachment 208 is provided that allows the hands-free head 190 to be clamped to any location needing a hands-free water source, such as a wash basin or automatic shower. Mounting plates 210 and 212 are also provided that accept mounting bracket 204 and allow for the removeable attachment of bracket 204 to surfaces, such as the outside of the housing 102, or any other surface where attachment of the hands-free head 190 would be useful.

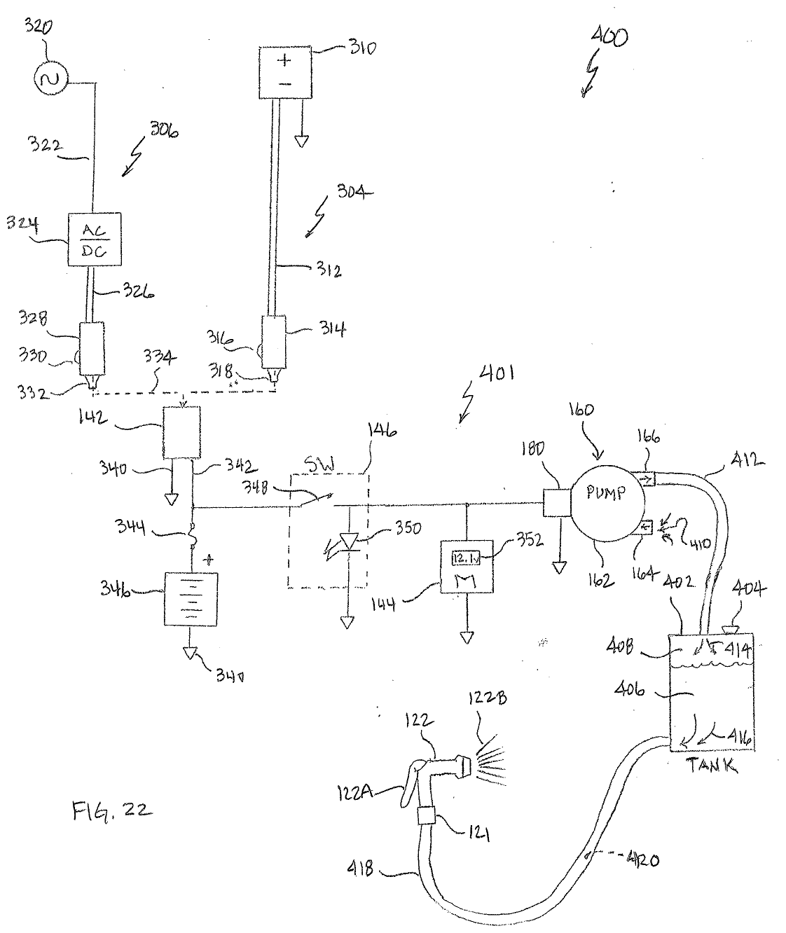

Referring now to FIG. 20, mounting bracket 204 is shown and includes a base 216 that is sized to be received in mounting plates 212 as shown by dashed lines 214. Removal of base 216 from mounting plate 212 may be achieved by squeezing base 216 and urging mounting bracket 204 away from mounting plate 212. Mounting bracket 204 includes a circular receiver 217 sized to receive tube 197 of hands-free head 190 and can be secured with threaded knobs 218.

While a variety of mounting devices 200 for hands-free head 190 are described herein, such descriptions are not limiting to the present invention as these are merely preferred embodiments of the present invention.

Referring now to FIG. 21, a schematic of the Portable Pressurized On-Demand Water Source 100 is shown and generally designated 300, and includes the pumping components 302, a DC charger 304 and an AC charger 306. DC charger circuit 304 includes a source battery 310, such as a recreational vehicle car battery, that is connected via cable 312 to a standard DC vehicle plug 314 having a grounding tab 316 and a positive tab 318. In some embodiments of the present invention, DC charger circuit 304 may include connection to a standard vehicle DC receptacle, such as what is commonly known as a cigarette lighter receptacle. These DC receptacles are typically known to provide up to ten (10) DC Amps, and is suitable to power the Portable Pressurized On-Demand Water Source 100 described herein. Alternatively, the DC charger circuit 304 may connect to a vehicle's 6-pin trailer receptacle which typically provides up to twenty (20) DC Amps. While this large current capacity is not required to operate the pumping components of the present invention, such connection to the trailer receptacle is external to the vehicle and often the most convenient for use.

In addition to the electrical connections to a typical vehicle electrical system using the cigarette receptacle and trailer receptacle, it is also contemplated herein to connect the Portable Pressurized On-Demand Water Source 100 to electric vehicles which are equipped with battery systems having a far greater capacity for charging the battery within the Portable Pressurized On-Demand Water Source 100, or operating the water source directly from the vehicle batter. In this configuration with an electric vehicle, the Portable Pressurized On-Demand Water Source 100 may be integrated into the vehicle itself drawing power directly from the vehicle power system, or a high capacity electrical connection to the vehicle power system may be provided.

AC Charger circuit 306 includes an AC power source 320, such as a house 120 VAC house outlet, which is connected via cable 322 to AC/DC converter 324 which converts the 120 VAC electricity to 12-14 VDC which is then connected via cable 326 to a standard DC vehicle plug 330 having a grounding tab 330 and a positive tab 332. DC charger 304 and AC charger 306 can be used interchangeably with pumping components 302 depending on the power source available.

Pumping components 302 include a DC receptacle 142 that has its negative lead 340 establish a circuit ground, and a positive lead 342 establish an input voltage. This input voltage passes through fuse 344 to charge battery 346. While fuse 344 is shown, it is not essential and can be omitted from the circuit, or alternatively, it could be replaced by an appropriate resettable circuit breaker. The presence of a fuse or resettable circuit breaker provides a measure of fault prevention in the event that an over-current event occurs as the result of a charger malfunction or pump failure.

Battery 346, in a preferred embodiment, is a sealed lead-acid battery suitable for its relatively low cost, durability, long life and ease of maintenance. However, it is to be appreciated that other rechargeable battery types may be used, including but not limited to nickel-metal-hydride, nickel-cadmium, and lithium-ion, without departing from the present invention. Additionally, in an alternative embodiment, non-rechargeable batteries may be used. In yet another alternative embodiment, an internal battery 346 may be omitted with the voltage input from DC charger 302 or AC charger 304 being directly connected to positive led 342 and switch 146.

Positive lead 342 is attached to switch 146 such that when switch 146 is open, no voltage passes, but when switch 146 is closed, voltage passes through switch 146 to the remainder of the circuit 302. In a preferred embodiment, switch 146 may include a light emitting diode (LED) 350 that receives voltage from the switched side of switch 146 such that LED 350 lights when the switch is in the ON position. The switched output of switch 146 is connected to the input of volt meter 144. Voltmeter 144, in a preferred embodiment, includes a digital voltage readout 352 that provides the user with constant updates as to the voltage level of battery 346. This voltmeter 144 may be equipped with a low-voltage alarm to notify a user when the battery 346 is depleted and passes under a minimum voltage limit to warn of a low battery condition thus preventing damage to the battery and pump.

Positive lead 342 is also provided to pump 160. As discussed above in conjunction with FIG. 11, pressure regulator 180 receives input voltage from positive lead 342 and if the pressure on the output side 166 of pump 162 is below the pressure regulator 180 preset maximum, voltage passes through pressure regulator 180 to pump 162. When pump 162 is on, water 360 is drawn from reservoir 152 in direction 362 and through inlet hose 154 to pump inlet 164. Pump 162 pressurizes water 360 which flows through pump outlet 166 to hose 120, through quick-disconnect coupler 121 and to spray nozzle 122. When spray nozzle lever 122A is pressed, water 360 exits spray nozzle 122 as spray 122B. However, when spray nozzle lever 122A is not pressed, the water pressure 370 in hose 120 continues to increase until the point where the pressure in hose 120 exceeds the maximum pressure of pressure regulator 180 which then causes the regulator to interrupt the voltage to pump 162.

As water 360 is drawn out of reservoir 152 in direction 362, air enters void 364 through air vents 130 of cap body 128 to avoid any vacuum forming in reservoir 152 which would decrease the flow rate of water as the vacuum increased. However, deformable vent seal 132 only allows air to enter reservoir 152 and prevents any water from leaving air vents 130 in the event that the device is tipped over.

Referring now to FIG. 22, a schematic of an alternative embodiment of the Portable Pressurized On-Demand Water Source 100 is shown and generally designated 400. The DC charger and AC charger are similar to FIG. 21, with some variation to the pumping components 402 that provide for a pressurized tank 402 that provides water to spray nozzle 122. Specifically focusing on pumping components 402, positive lead 342 is provided to pump 160. Pressure regulator 180 receives input voltage from positive lead 342 and, if the pressure on the output side 166 of pump 162 is below the pressure regulator 180 preset maximum, voltage passes through pressure regulator 180 to pump 162. When pump 162 is on, air 410 is drawn into pump 162 and pressurized air exits pump outlet 166. The pressurized air passes through hose 412 and enters tank 402 as shown by flow 414 and into air gap 408. As air flows into air gap 408, the pressure inside tank 402 increases to push water 406 in direction 416 and into hose 418. If nozzle lever 122A is pressed, water passes through spray nozzle 122 and exits as spray 122B. However, if spray nozzle 122 is not open, the pressure 420 in hose 418 increases causing the same increase in pressure within tank 402 and hose 412. As the pressure in tank 402 and hose 412 increase to the maximum preset pressure of pressure regulator 180, voltage to pump 162 is interrupted. Once spray nozzle 122 is opened by pressing spray nozzle lever 122A, the pressure in hose 418, tank 402 and hose 412 decreases. Once the pressure decreases below the maximum preset pressure of pressure regulator 180, the voltage is restored to pump 162 and air is once again pumped into tank 402. In this embodiment, it is to be appreciated that cap 404 to tank 402 is a sealed cap; however, it may be equipped with an over-pressure relieve valve to ensure against the over pressurization of tank 402.

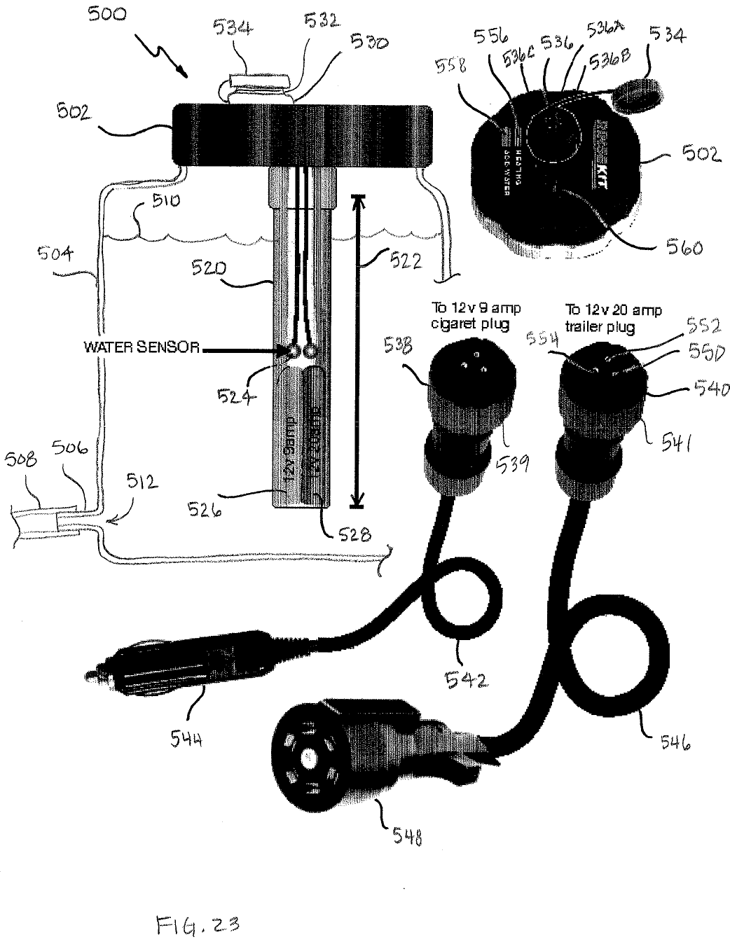

Referring now to FIG. 23, an alternative embodiment of the Portable Pressurized On-Demand Water Source is shown and generally designated 500. System 500 includes a lid 502 sealing a reservoir 504 that is formed with a water outlet 506 connected to a water hose 508. In use, as described above in connection with other embodiments of the Portable Pressurized On-Demand Water Source, water 510 in reservoir 504 flows in direction 512, through outlet 506 and into water hose 508 to pump 160.

Portable Pressurized On-Demand Water Source 500 includes a lid 502 having a heater probe 520 having a length 522 corresponding to the depth of reservoir 504 and includes a water sensor 524 to determine the level of water 510 in reservoir 504. Heater probe 520 also includes a first heater element 526 and a second heater element 528. In a preferred embodiment, first heater element 526 is designed to accommodate a 12VDC 9 Amp source to heat the water 510 in reservoir 504. Alternatively, the second heater element 528 is designed to accommodate a 12VDC 20 Amp source to heat the water 510 in reservoir 504.

Lid 502 is shown with an electrical receptacle 536 having three input terminals 536A, 536B, and 536C. Portable Pressurized On-Demand Water Source 500 includes two separate electrical connections 538 and 540. Electrical connection 538 includes a threaded hood 539 sized to threadably engage threads 532 of connector 530 on lid 502 to connect connection 538 to connector 530 establishing an electrical connection therebetween. Cord 542 extends from connector 538 to a DC plug 544, such as those typically insertable into a vehicle DC receptable. Alternatively, electrical connection 540 includes a threaded hood 541 sized to threadably engage threads 532 of connector 530 on lid 502 to connect connector 540 to connector 530 establishing an electrical connection therebetween. Cord 546 extends from connector 540 to a DC plug 548, such as those typically used in vehicle trailer connections. This vehicle trailer connection provides 12 VDC at a capacity of 20 Amps to provide a higher current for heating water 510.

Because connector 538 and connector 540 only utilize two conductors to provide the electrical power to their respective heating elements (12 VDC (+) and GND (−)), connector 536 is configured with a common ground pin, such as pin 536A, while the remaining pins 536B and 536C may be used to connect either the 9 Amp or 20 Amp connectors 538 or 540. For instance, connector 540 would have a ground pin for pin 550, and the 12 VDC and 20 Amp connection would be to pin 552, with the third pin 554 unconnected. Conversely, on connector 538, the pin corresponding to pin 552 would be disconnected, and the pin corresponding to pin 554 would be connected to the 12 VDC and 9 Amp connection. Other pin and connection configurations could be used without departing from the present invention.

When the water level is higher than water sensor 524, the water sensor 524 allows the heater elements 526 or 528 to be energized. However, when the water level becomes below water sensor 524, power to heater elements 526 or 528 is interrupted thereby preventing an overheating of the heating elements, or a super-heating of the water 510 to an over-temperature level. Also, each heating element 526 and 528 is equipped with an internal thermostat that is preset to a desired temperature such that when the heating elements are “ON”, a maximum temperature will be reached but not exceeded.

Lid 502 is formed with a vent 560 which, like vent 130 of cap 126, allow for air to pass from ambient into the reservoir 504 to allow water 510 to freely flow from reservoir 504 without the creation of a vacuum therein. Additionally, vent 560 will allow air to pass from the reservoir 504 to ambient in the event that the water 510 expands due to the increase in temperature due to heater elements 526 or 528, and to avoid a build-up of pressure in reservoir 504.

Lid 502 of the Portable Pressurized On-Demand Water Source 500 is also equipped with a pair of status indicators, such as “Heating” status indicator 556 that lights when the heating elements 526 or 528 are “ON”. A second indicator is an “Add Water” indicator that notifies the user when the water level has passed below the water sensor 524 level.

While there have been shown what are presently considered to be preferred embodiments of the present invention, it will be apparent to those skilled in the art that various changes and modifications can be made herein without departing from the scope and spirit of the invention.

What is claimed is:

1. A portable pressurized on-demand water source, comprising:
a housing having a lid;
a reservoir within the housing;
a chassis within the housing and equipped with a control panel;
a pump;
a battery configured to provide power to the pump; and
a dispensing apparatus within the chassis, the dispensing apparatus engageable to dispense water,
wherein the pump is configured to provide pressurized water to the dispensing apparatus.

2. The portable pressurized on-demand water source of claim 1, wherein the lid has a closed configuration in which it covers the chassis and the reservoir, an open configuration providing access to the chassis, and a detached configuration in which the lid is separated from the housing.

3. The portable pressurized on-demand water source of claim 1, wherein the dispensing apparatus comprises a hose.

4. The portable pressurized on-demand water source of claim 3, wherein the housing comprises a notch configured to allow the hose to be in an extended configuration in which it extends from inside the housing to outside the housing while the lid is in the closed configuration.

5. The portable pressurized on-demand water source of claim 3, wherein the dispensing apparatus further comprises a handheld nozzle.

6. The portable pressurized on-demand water source of claim 3, wherein the dispensing apparatus further comprises a hands-free head.

7. The portable pressurized on-demand water source of claim 6, wherein the hands-free head comprises an internal battery and motion sensor configured to cause the hands-free head to dispense water when motion is detected.

8. The portable pressurized on-demand water source of claim 7, wherein the hands-free head further comprises a USB port configured to facilitate charging of the internal battery of the hands-free head.

9. A portable pressurized on-demand water source, comprising:
a housing having a lid;
a reservoir within the housing;
a chassis within the housing and equipped with a control panel;
a hose having a quick-disconnect coupler;
a water dispenser removably connected to the hose via the quick-disconnect coupler;
a pump configured to provide pressurized water to the water dispenser; and
a battery configured to provide power to the pump.

10. The portable pressurized on-demand water source of claim 9, wherein the control panel comprises a charging port, a battery status meter, and an on-off switch.

11. The portable pressurized on-demand water source of claim 9, wherein the battery comprises a sealed lead-acid battery.

12. The portable pressurized on-demand water source of claim 9, further comprising a connector for a vehicle electrical system, the connector configured to provide power for charging the battery.

13. The portable pressurized on-demand water source of claim 12, wherein the connector comprises a connector for a standard vehicle DC receptacle.

14. The portable pressurized on-demand water source of claim 12, wherein the connector comprises a connector for a trailer receptacle.

15. The portable pressurized on-demand water source of claim 9, wherein the water dispenser is a handheld nozzle.

16. The portable pressurized on-demand water source of claim 9, wherein the water dispenser is a hands-free head comprising an internal battery and motion sensor configured to cause the hands-free head to dispense water when motion is detected.

17. The portable pressurized on-demand water source of claim 16, wherein the hands-free head further comprises a USB port configured to facilitate charging of the internal battery of the hands-free head.

18. A portable pressurized on-demand water source, comprising:
a reservoir;
a water sensor configured to determine the level of water in the reservoir;
a lid configured to seal the reservoir;
a water level indicator located on the lid and configured to indicate when a water level in the reservoir is below a predetermined low water level;
a water outlet formed into the reservoir;
a water hose attached to the water outlet;
a pump having an input connected to the hose and an output;
a dispensing hose connected to the output of the pump; and
a water dispenser connected to the dispensing hose.

19. The portable pressurized on-demand water source of claim 18, further comprising a heater probe comprising a first heater element configured to heat water in the reservoir, and wherein the lid comprises an electrical receptacle receptacle configured to receive power from a vehicle electrical system to power the heater probe.

20. The portable pressurized on-demand water source of claim 19, wherein the heater probe further comprises a second heater element, the first heater element configured to use a nine-ampere electrical source to heat water in the reservoir, and the second heater element configured to use a twenty-ampere electrical source to heat water in the reservoir.
